(19) United States
(12) Patent Application Publication
(10) Pub. No.: US 2017/0067682 A1
(43) Pub. Date: Mar. 9, 2017

(54) Multipurpose Ice Chest

(71) Applicant: Mark V. Spinks, Pheonix, AZ (US)

(72) Inventor: Mark V. Spinks, Pheonix, AZ (US)

(21) Appl. No.: 15/258,335

(22) Filed: Sep. 7, 2016

Related U.S. Application Data
(63) Continuation of application No. 62/216,000, filed on Sep. 9, 2015.

(51) Int. Cl. F25D 23/12; F25C 1/00; H02S 10/40; F25D 3/06

(52) U.S. Cl. CPC F25D 23/12; F25D 3/06; F25C 1/00; H02S 10/40; F25D 2400/38; F25D 2400/40; F25D 2700/121; F25D 2303/081; F25C 2700/04; F25C 2700/14

(57) ABSTRACT

The present invention is a multipurpose ice chest. The device having an insulated storage chest with a water reservoir in its base, an ice maker with a water uptake system from the reservoir affixed to the inside of the insulated storage chest, an air conditioning unit having a submersible pump within the reservoir in fluid communication with a radiator and a fan that draws air through the radiator reducing the temperature of the air being drawn through the radiator, an electronic control unit in electronic communication with the ice maker and the air conditioning unit and a means for generating and storing energy connected to the electronic control unit.

### CROSS-REFERENCE TO RELATED APPLICATIONS

This application claims priority to U.S. Provisional Application Ser. No. 62/216,000 filed on 7 Sep. 2015 which is incorporated herein in its entirety by this reference.

### STATEMENT REGARDING FEDERALLY SPONSORED RESEARCH OR DEVELOPMENT

Not applicable

### THE NAMES OF THE PARTIES TO A JOINT RESEARCH AGREEMENT

Not applicable

### INCORPORATION-BY-REFERENCE OF MATERIAL SUBMITTED ON A COMPACT DISC

Not applicable

### TECHNICAL FIELD

The present invention relates generally to camping and/or emergency/disaster relief equipment. More specifically, to devices that offer a unique light weight, compact and portable device to perform multiple functions of keeping refrigerated foods cold while at the same time offering air conditioning and energy storage for general use.

### BACKGROUND OF THE INVENTION

There are a number of conveniences that campers like to have when camping. These include items such as: a cooler to keep drinks from getting warm and food items from going bad; air condition to make the environment in a tent of camper more comfortable in warm weather; a power source for running equipment such as lights, phones, computer, and the like and extra ice for keeping the food in the cooler fresh. In addition, a variety of equipment can be beneficial to have in a single compact unit for emergency circumstances that can result from floods, hurricanes, tornadoes, civil unrest and the like that leave individuals without the necessities needed for survival. Unfortunately, many of these items are generally provided in separate units that must be packed and stored during the trip or relief effort. These may be additional coolers not just for food but for additional ice, a separate air conditioning unit that may be powered by a battery or generator, additional power sources such as batteries and or a generator and fuel for the generator. A number of devices have been developed that combine two or more of these devices. For example, there are a number of device combining a ice chest with an air conditioner, using the ice in the chest to lower the temperature of the air being drawn over a radiator containing the ice water or over the ice in the chest. Unfortunately, this only provides a brief respite from the heat because the ice tends to melt quickly and then the camper is left with no ice to cool the perishables in the cooler and no relief from the heat. U.S. Pat. Nos. 6,571,963; 7,603,875 and 7,748,235 describe three devices that utilize this type of system to cool air.

Another device combines an ice maker in an ice chest to recycle the melted ice and form new ice to maintain the temperature in the ice chest. U.S. Pat. No. 8,307,664 provides a reservoir in the base of the ice cooler from which the ice maker draws water into its freezing chamber to recreate ice which once solid is dispensed back into the ice chest. Unfortunately, a significant amount of energy is required to create ice and therefore this device is limited in its ability over the long term to keep the contents of the ice chest cooled with ice based on stored energy.

Securing energy from sources other than an electrical outlet in combination with an ice chest has also been developed. U.S. Pat. No. 8,353,167 is a cooler having solar panels that generate energy to keep the contents of the ice chest refrigerated. Unfortunately, this is limited to performing only the single function of keeping the food within the ice chest refrigerated and does not serve the other needs of the camper.

As such, there is a continuing unmet need for a device that is fully self-sufficient and self-sustaining when in remote locations or during emergencies when there is limited or no access to the power grid. More specifically, a device that can provide a cooler for storage and safe keeping of food and drinks, that can recycle melted ice water to make ice and deposit the ice back into the cooler, that provides an air conditioning function utilizing the temperature of the melted ice water to cool air and an energy generating capability all in one compact device for emergency circumstances or for pleasure.

The forgoing examples of related art and limitation related therewith are intended to be illustrative and not exclusive, and they do not imply any limitations on the invention described and claimed herein. Various limitations of the related art will become apparent to those skilled in the art upon a reading and understanding of the specification below and the accompanying drawings.

### SUMMARY OF THE INVENTION

The device herein disclosed and described is a multipurpose ice chest. The device having an insulated storage chest with sides and a base, a water reservoir in the base of the insulated storage chest, an ice maker affixed within the insulated storage chest having a water uptake system in fluid connection with the water reservoir, an ice making chamber for receiving water from the water uptake system, an ice releasing means for dispensing ice from the ice making chamber into the insulated storage chest and an electronic means for controlling the ice maker, wherein the electronic means having a sensor for determining the level of water in the water reservoir; an air conditioning unit, wherein the air conditioning unit having a submersible pump within the water reservoir, wherein the submersible pump having an inlet conduit and an outlet conduit, a radiator having an inlet port connected to the inlet conduit and an outlet port connected to the outlet conduit and a fan affixed to the radiator for drawing air through the radiator reducing to reduce the temperature of the air, an electronic control unit in electronic communication with the ice maker and the air conditioning unit; and a means for generating and storing energy, the energy generating and storage means connected to the electronic control unit.

In certain embodiments, the energy generating and storage means is a solar panel and the solar panel may further comprise an electrical tether and a structural scaffold for maintaining the solar panel in position during use, the structural scaffold may be integral to or separable from the insulated storage chest and the sensor for determining the level of water in the water reservoir may be a float.

With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures and systems for carrying out the several purposes of the present disclosed device. It is important, therefore, that the claims be regarded as including such equivalent construction insofar as they do not depart from the spirit and scope of the present invention.

The objects, features, and advantages of the invention will be brought out in the following part of the specification, wherein detailed description is for the purpose of fully disclosing the invention without placing limitations thereon.

### BRIEF DESCRIPTION OF THE DRAWINGS

FIG. 1 shows an exploded view of one embodiment of a device of the present invention. The submersible pump's inlet and outlet conduits going to the inlet and outlet ports of the radiator as well as the electrical connections between the elements of the device and the control unit are not shown in the figure.

FIG. 2 shows an exemplary flow scheme of one embodiment of a device of the present invention utilizing solar generated energy.

### DETAILED DESCRIPTION OF THE INVENTION

Unless defined otherwise, all terms used herein have the same meaning as are commonly understood by one of skill in the art to which this invention belongs. All patents, patent applications and publications referred to throughout the disclosure herein are incorporated by reference in their entirety. In the event that there is a plurality of definitions for a term herein, those in this section prevail.

The term “affixed” as used herein refers to the connecting of one or more panels of material that make up the hovering air fort of the present invention. This term includes stitching, fusing temperature sensitive material through heat and/or the use of an adhesive. These are just a few methods of fastening one or more pieces of fabric, cloth or textile to one another and will include other methods known to those skilled in the art.

The term “insulated” as used herein refers to any materials utilized by those skilled in the art to maintain the internal temperature of an item such as the interior of an ice or storage chest or a water line such as those that may be incorporated in an ice maker water uptake system or the inlet and outlet conduit of a submersible pump. For example, an ice chest may have a double wall configuration wherein the space between the walls is air of filled with semi-flexible or hard foam that helps to reduce the change in temperature of the interior of the chest as compared to the outside environment in which the chest resides. As another example the conduit lines extending from the submersible pump to the radiator may be wrapped together or individually with a temperature resistant material that reduces a potential change in temperature of the fluid flowing through these conduits based on the difference of the fluids temperature in comparison to the environmental temperature.

The term “ice releasing means” as used herein refers to an element or grouping of elements that when activated operate to remove newly formed ice from an ice making chamber or tray into an ice or storage chest. A variety of methods for performing this function are known in the art. Examples include such ice releasing means utilized in refrigerator ice makers and commercial ice making machines.

The term “electronic means” or “electrical means” as used herein refer to electronic circuitry constructed in such a way to provide the control and energy necessary to operate mechanical elements of a device to perform a desired function. For example, an electronic means that provides an electronic circuitry to activate the ice releasing means to deposit ice in the ice or storage chest at a desired time when the ice is completely formed in the ice making chamber or tray.

The term “means for generating and storing energy” as used herein refers to any method know to those in the art for collecting energy from another energy source and storing that energy for later use. For example, other energy sources include wind, rushing water, sun light, or another energy storage facility providing such energy for use or storage. These sources collect energy utilizing windmills, dams and solar panels. A means for generating and storing energy could for example include a solar panel for collecting energy from sun light connected to a battery for storage of that energy for later use.

One aspect of the present invention is a multipurpose ice chest. The device having an insulated storage chest with sides and a base, a water reservoir in the base of the insulated storage chest, an ice maker affixed within the insulated storage chest having a water uptake system in fluid connection with the water reservoir, an ice making chamber for receiving water from the water uptake system, an ice releasing means for dispensing ice from the ice making chamber into the insulated storage chest and an electronic means for controlling the ice maker, wherein the electronic means having a sensor for determining the level of water in the water reservoir; an air conditioning unit, wherein the air conditioning unit having a submersible pump within the water reservoir, wherein the submersible pump having an inlet conduit and an outlet conduit, a radiator having an inlet port connected to the inlet conduit and an outlet port connected to the outlet conduit and a fan affixed to the radiator for drawing air through the radiator reducing to reduce the temperature of the air, an electronic control unit in electronic communication with the ice maker and the air conditioning unit; and a means for generating and storing energy, the energy generating and storage means connected to the electronic control unit.

Insulted Storage Chest

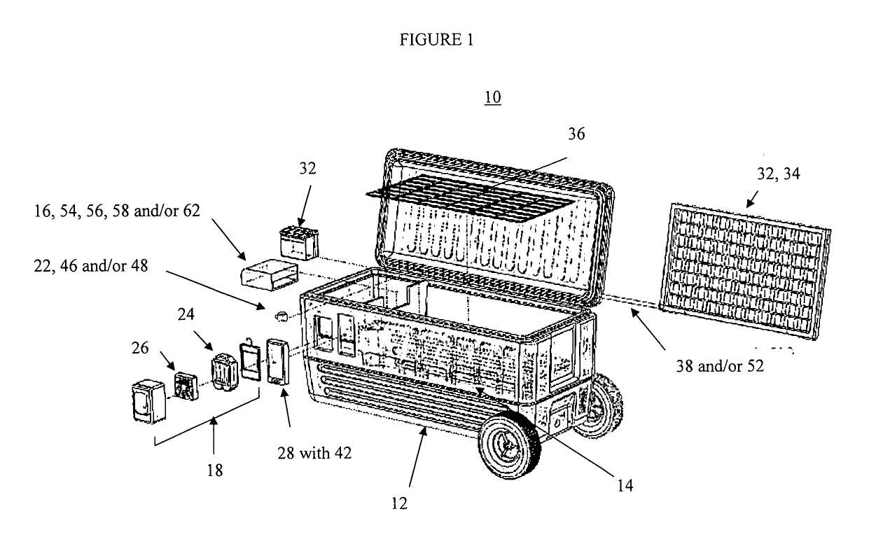

The insulated storage chest of the present invention 10 is comprised of a storage chest and a lid for securing the contents in the device (see FIG. 1). The chest may be any size but is preferably of a size easily manipulated and transported for activities such as for leisure (parties, travel, camping, etc.) humanitarian efforts (providing food or fluid storage during emergencies) or work or commercial activities (providing food or fluid at work sites). Sizes include 44 to 150 quarts with some of the most common sizes sold commercially being 48, 52 and 60 quarts.

The chest may be provided in a double walled construction containing insulation material between the two walls. This insulation material may be air or empty space, a foam such as Styrofoam™ (a semi-rigid polystyrene material) a fiber such as fiberglass (a fiber mesh made of fine glass filaments) or any other material known to those skilled in the art that may provide a insulting function for preserving temperature in a chamber.

For convenience the chest may be provided with a set of wheels on one end for easy transport on flat relatively hard surfaces. In this configuration, there is a handle provided on the opposite end of the chest that allows the user to lift that end off the ground. When this is done the user is able to roll the chest to a desired location on the wheels. In another configuration, the chest may have wheels at all four corners. For easy of transport one or both ends of the chest may be provided with a leash, tether or handle that allows the use to roll the chest to a desired location.

The base of the storage chest 12 becomes the fluid reservoir 14 from which the ice maker 16 and the radiator 24 of the air conditioner 18 draw melted ice water or cooled water that has been placed in the reservoir 14. The reservoir 14 is separated from the rest of the storage chest 12 by a divider 36 that is permeable to fluid. This divider 36 may be a permeable wall or a storage rack. A permeable wall could be made of a variety of materials such as polymer having a porosity that allows the transport of fluid from the chamber to the reservoir 14. This could be a poly mesh, permeable matrix or holes. The size of the porosity will depend on the selectivity desired. If only water is desired to pass through from the chamber into the reservoir 14 then the porosity will act as a filter and will generally be small preventing large particles from reaching the reservoir 14. If some selectivity is desired, for example reducing the particle sizes that could clog the submersible pump 22 intake port, then one millimeter sized holes may be beneficial. If selectivity is of limited concern the holes can be much larger. If no selectivity is required then a metal or polymer rack having apertures 25 millimeters square or larger can be utilized. One skilled in the art can determine what porosity would be best based on the desired or intended function of the device 10.

To provide a compact device 10 that may be easily stored, manipulated and utilized effectively and efficiently the storage chest 12 may also comprise means for receiving and securing the other elements the device. The receiving and/or securing means for the ice maker 16, positioned in the upper portion of the chest 12 near the lid, may be hooks for holding the ice maker 16 in place during use while allowing the ice maker 16 to be easily removed or replaced as desired. Alternatively, the ice maker 16 may be secured within the storage chest 12 by screws, clips or other similar methods known to those skilled in the art for securing an ice making device 16 in a refrigerated or climate controlled environment. The electronic connector between the ice maker 16 and the control unit 28 may be provided on the exterior of the interior wall of the storage chest 12 with the wires coming from the control unit 28 secured within the space between the double wall construction of the storage chest 12. This electronic connector may further comprise a waterproof or water resistant cover or sheath to protect the wires from discharging electricity due to the presence of water. In another configuration, the storage chest 12 provides a shelf and docking port that allows the ice maker 16 to be connected electronically to the control unit 28 and secured removably on the shelf simultaneously when inserted into the docking port.

The receiving and securing means for the control unit 28 may be a chamber or docking port in the side of the storage chest 12. If the control unit 28 is self-contained with a view screen and control panel on one side and the electronic connector on the other side, a clip-in or snap-in chamber having a size and shape similar to the control unit 28 that is slightly larger to allow for the unit to be easily inserted and removed can be provided. This configuration would allow the control unit 28 to be connected electronically to the other elements of the device simultaneously when inserting the control unit 28 into the docking port. Alternatively, the control unit 28 may be built into the storage chest 12 and secured in place by screws, rivets, adhesive or other similar methods known to those skilled in the art for securing an electronic unit 28 to a device 10 that contains fluid in a refrigerated or climate controlled environment. A majority of the length of the wires connecting the control unit 28 to the other elements of the device 10 are secured within the space between the double wall construction of the storage chest 12.

The receiving and securing means for the air conditioning unit 18 may be a chamber with a space provided for maintaining the tether that contains the electrical wiring and fluid conduits of the fan 26 and radiator 24 in the side of the storage chest 12. A clip-in or snap-in chamber having a size and shape similar to the air conditioning unit 18 that is slightly larger to allow for the unit to be easily inserted and removed can be provided. During use it may be beneficial to maintain the air conditioning unit 18 within the storage chest 12. In this circumstance the air conditioning unit 18 is activated and remains docked. However, in the event that the storage chest 12 is not stored in the same location in which the temperature is to be controlled, such as a small tent, the air conditioning unit 18 may be disconnected from the storage chest 12, the tether extended and the unit positioned in the location desired. The tether, that contains the electrical wiring to the fan 26 and the inlet conduit and outlet conduit to the radiator 24, may be provided in pre-coiled line that will easily recoil after use for inserting into the space provided for the tether in the chamber. The wire(s) connecting the fan 26 to the control unit 28 may be secured within the space between the double wall construction of the storage chest 12.

The receiving and securing means for the submersible pump 22 may be a chamber in the base of the storage chest 12 below the fluid reservoir 14 or the pump 22 may be secured within the reservoir 14 on the base of the storage chest 12. A clip-in or snap-in chamber having a size and shape similar to the submersible pump 22 that is slightly larger to allow for the unit to be easily inserted and removed can be provided. If this chamber were a docking port, it would allow the submersible pump 22 to be connected electronically to the control unit 28 simultaneously when inserting the submersible pump 22 into the docking port. The submersible pump 22 will have an inlet conduit for obtaining fluid from the fluid reservoir 14 and an outlet port for transporting the fluid to the radiator 24 of the air conditioning unit 18. The inlet conduit may extend slightly above, be flush with or be slightly below the base of the storage chamber. In addition, the inlet conduit may further comprise a filter to prevent particulates that could clog the submersible pump 22 from entering the pump. In this configuration the filter will be provided as an easily removable element for cleaning or replacement purposes. Alternatively, the submersible pump 22 may be built into the storage chest and secured in place by screws, rivets, adhesive or other similar methods known to those skilled in the art for securing an submersible pump 22 to a device that contains fluid in a refrigerated or climate controlled environment. A majority of the length of the wires connecting the submersible pump 22 to the control unit 28 are secured within the space between the double wall construction of the storage chest 12.

The receiving and securing means for the energy generating means 32 may be a chamber in the top of the lid, or one or more of the sides of the storage chest 12. The energy generating means 32 could be a fan that may be utilized for wind or may double for placing in a body of water, such as a stream, to generate energy from the current. In a preferred embodiment the energy generating means is a solar panel 34. When using any of these energy generating means, a clip-in or snap-in chamber may be provided with a space for maintaining a tether, that contains the electrical wiring to the control unit 28 and energy storage means. The chamber having a size and shape similar to the energy generating means that is slightly larger to allow for the unit 32 to be easily inserted and removed can be provided. If this chamber were a docking port, it would allow the energy generating means 32 to be connected electronically to the control unit 28 simultaneously when inserting the energy generating means 32 into the docking port. During use, it may be beneficial to maintain the energy generating means 32 within the storage chest. In this circumstance, the energy generating means 32 is activated and remains docked collecting and transferring energy for storage to the energy storage means 32. However, in the event that the storage chest 12 is stored in a location that is separate from access to wind, light or running water, such as in a tent, the energy generating means 32 may be disconnected from the storage chest 12, the tether extended and the means positioned in the location that is acceptable for obtaining or receiving energy.

In addition, because the device has an energy storage capability, it may be charged through an external power source such as a DC outlet in a vehicle or an AC outlet in a home or recreational vehicle before being deployed.

The ice maker 16, control unit 28, air conditioning unit 16, submersible pump 22 and energy storing means 32 may be positioned at different locations along the walls of the insulated storage chest 12 or they may be grouped together in a single chamber on one side of the device 10. This single chamber may be water proof or water resistant to protect the electronics of these elements. One skilled in the art will recognize that the inlet and outlet conduits of the radiator 24, the fluid uptake system of the ice maker 16 and the releasing means for dispensing ice from the ice maker 58 into the insulated chest 12 will require communication with the fluid reservoir 14 and/or the food storage area. Consequently, these connections will be provided in such a way that they prevent fluid from entering into the electronics of the device 12. In one example, the interior chamber of the insulated storage chest 12 is divided into two sections; one section for storage of food and for the fluid reservoir 14 and the other for affixing the ice maker 16, control unit 28, air conditioning unit 18, submersible pump 22 and energy storing means 32.

Methods for constructing ice chests are well known. A number of commercial providers include Orca (Nashville, Tenn.), Yeti (Austin, Tex.), Pelican (Torrance, Calif.), Igloo (Katy, Tex.), Engel Jupiter, Fla.), Coleman (Golden, Colo.), Grizzly (Decorah, Iowa) and Rubbermaid (High Point, N.C.). Any one of these providers may be utilized to provide an insulated storage chest having the desired configuration for incorporating the other elements of the present invention.

Fluid Reservoir

The base of the insulated storage chest 12 is utilized as a fluid reservoir 14 to collect fluid or water from melting ice. Ridges, extensions or protrusions along the interior of the walls of the insulated storage chest 12 may be provided for supporting or securing a permeable divider 36 along its edges above and parallel to the base of the insulated storage chest 12. Alternatively, the divider 36 may have extensions or feet along its edges on one side that help support it above and parallel to the base of the insulated storage chest 12 at a desired height. This divider 36 may be a permeable wall or a storage rack. As discussed above the permeable wall 36 may be made of a variety of materials such as a polymer having a porosity that allows the transport of fluid from the chamber to the reservoir 14. This could be a polymer mesh, permeable matrix or holes. The size of the porosity will depend on the selectivity desired. If only water is desired to pass through from the chamber into the reservoir 14 then the porosity will act as a filter and will generally be small preventing particulates from reaching the reservoir 14. If some selectivity is desired, for example reducing particulates to a size that cannot clog the submersible pump 22 intake port, then one millimeter sized holes may be beneficial. If selectivity is of limited concern the holes could be larger. If no selectivity is required, then a metal or polymer rack having apertures of 25 millimeters or larger could be utilized. In another configuration, the divider 36 is a rack that is secured in place by press-fitting into grooves provided in four or more protrusion along the interior walls of the insulated storage chest 12 positioned at equal height at about 50 to 130 millimeters above the base of the chest 12.

In other embodiments of the present invention, the base of the insulated storage chest 12 may be relatively flat or level with the ground, it may be sloped to one side and directed to the inlet conduit of the submersible pump 22 and/or the water uptake system of the ice maker 16, or it may be sloped to a particular area of the base near the location of the inlet conduit and/or water uptake system 54 for the ice maker 16.

Ice Maker

A variety of ice makers 16 sold commercially may be utilized with the present invention. For example, the ice maker elements of the Igloo ICE 102-Red compact ice maker may be used in the present device. A number of refrigerator ice makers may also be repurposed to operate in the present invention, for example, the Frigidaire refrigerator ice maker replacement model no. 241798224, the Whirlpool refrigerator ice maker replacement model no. 4317943 D7827406Q, the GE refrigerator ice maker replacement model no. WR30X10093 and the Sears Refrigerator Ice Maker assembly model no. 5989JA002P. Each of these ice makers 16 contains a water uptake 54 or receiving system, an ice making chamber 56, an ice releasing means 58 and an electronic means 62 for providing energy to operate the ice maker 16. In the present invention, the water uptake system 54 extracts water from the fluid reservoir 14 when water is available for making ice. A sensor 64 is used to determine the amount of water in the reservoir 14 and trigger the initiation of water uptake when there is sufficient water in the reservoir 14 for making the next round of ice. A variety of sensors could be utilized for this purpose and can be a mechanical sensor, an optical sensor or an electronic sensor. A common sensor is a float sensor.

Air Conditioning Unit

The air conditioning unit 18 is comprised of a fan 26 connected to a radiator 24 for drawing air through the radiator 24. The radiator 24 has an inlet port and an outlet port which are connected to an inlet conduit and an outlet conduit of a submersible pump 22 that when activated circulates water through the radiator 24. The fan may be selected from a variety of fans sold commercially for cooling electronic equipment. For example, the Multifan S3 model no.: AI-MPF-120A by AC Infinity (City of Industry, CA), the Shark Fin model no.: ZM-SF3 by Zalman (Gyeonggi, Korea) and Multifan model no.: RFA-120-K by Rosewill (City of Industry, Calif.) or any similar fan may be utilized with the present invention. The fan 26 may be separate from or may be obtained with the radiator 24. For example, the ALSEYE Water Max 120, model no.: PWM 500-2000RPM (Shenzhen, China) and the Antec Liquid CPU Cooling System model no.: Kuhler H2) 650 (Fremont Calif.) both are sold with a fan, cooler and conduits. Alternatively, the radiator may be purchased separately. Exemplary radiators include the Alphcool 120 mm Radiator, model no.: Alphacool Nex Xxos ST30 (Portsmith, Queensland Australia) or the AGPtek radiator, model no.: BOOCFDS3JA (Brooklyn, N.Y.). A variety of fans, radiators and conduits are available commercially and one skilled in the art may select the appropriate size and power requirements as desired.

For convenience the radiator 24, fan 26 or the housing that supports the radiator 24 and fan 26 when separated from the insulated chest 12 during use may also have a collapsible or foldable base that allows the user to place the air conditioning unit 18 on a surface with the desired orientation. For example, the base of the housing holding the radiator 24 and fan 26 may have rotatable feet that extend from the bottom of the housing outward to form a platform to support the air conditioning unit 18 in an upright orientation. Alternatively the housing may also comprise pivotal arms that support the fan 26 and radiator 24 on the rotatable feet which allows the radiator 24 and fan 26 to be pivoted and direct the air flow. Alternatively, the top of the housing may have a hook that allows the user to hang the radiator 24 and fan 26 on the ceiling of a tent or the like. A variety of methods known to those skilled in the art may be employed to stabilize and direct the fan 26 and radiator 24 during use.

Submersible Pump

A variety of submersible pumps 22 may be used with the present invention and may be positioned on or within the base of the insulated storage chest 12. For example, there are a variety of EcoPlus submersible pumps that may be selected based on gallon per hour output. The EcoPlus 185 Submersible pump provides 185 gallon per hour (GPH) output (sold exclusively by Sunlight Supply, Inc., Ontario, Calif.). Other alternatives include the PE-1 Small Submersible Pump by Little Giant (Fort Wayne, Ind.) or the Aquascape ultra submersible pump model no.: 400 GPH Ultra Pump-91005 (St. Charles, Ill.). The actual flow in GPH will depend on the length of the tether connecting the air conditioning unit 18 to the insulated chest 12. However, one skilled in the art when viewing the device literature and specifications provided with the pump can determine which pump 22 to select for the desired output and effect.

Means for Generating and Storing Energy

A variety of means for collecting and storing energy 32 can be utilized with the present invention. The energy generating means 32 could be a fan that may be utilized for wind or may double for placing in a body of water, such as a stream, to generate energy from the current. In a preferred embodiment the energy generating means is a solar panel. A variety of companies that provide these types of energy generating devices are known including Goal Zero (Riverton, Utah) and Coleman (Golden, Colo.) provide portable solar panels, others such as GSE Solar Systems (Adelanto, Calif.) and Sun Module Solar Panels (Hillsboro, Oreg.) sell a variety of panels of different sizes for desired uses. Energy storage units are also available commercially. For example, Goal Zero (Riverton, Utah) sells a variety of units depending on desired storage capabilities. Other companies such as Grape Solar (Off-Grid Solar Electric Power Kit, model: GS-400-KIT, Eugene, Oreg.) and Renogy (Eclipse Solar Kit, model: RNG-KIT-PREMIUM 400MB-CMD40, Ontario, Canada) sell complete systems for collecting and storing energy for later use. Portable wind turbines can be purchased from Jiangsu Naier Wind Power Technology Development Co. Ltd. (Jiangsu, China) and Nanjing Oulu Electric Transmission Co. Ltd. (Nanjing, China). In addition, portable water turbines may be obtained from Aquakin (Furth, Germany). Depending on the desired energy storage, use output and collection requirements, one skilled in the art can select the appropriate collecting device (solar panel(s) 34, wind turbine(s) or water turbine(s)) to obtain the desired energy for the intended or anticipated use as well as the appropriate storage capability to maintain the desired amount of energy for a given period of time.

Electronic Control Unit

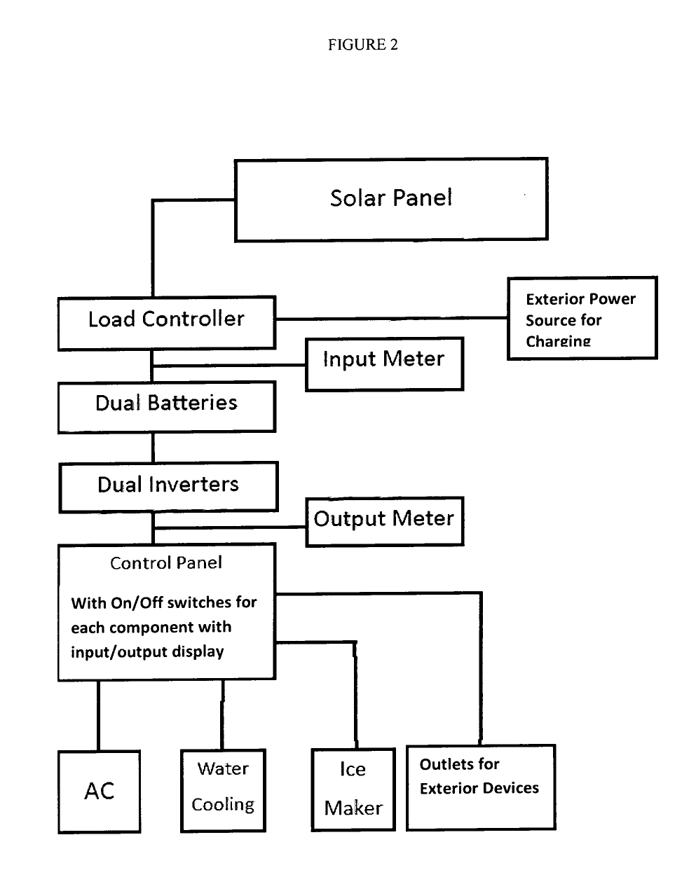

The electronic control unit 28 is connected to the energy storage means 32 for immediate transmission of electronic transmission of signals to or receiving reporting information from the electronically controlled elements of the present invention (see FIG. 2). To conserve energy the control unit 28 may have an “On/Off” switch which activates or deactivates the unit. The control unit 28 may have a display window to convey information to the user as well as an input keyboard or buttons to allow the user to provide specific commands to the elements of the invention. Information that may be conveyed includes for example, temperature readings for the interior and exterior of the device 10 as well as the temperature of the fluid in the reservoir 14, the amount of energy currently stored or being received from the energy generating means 32, the volume of fluid in the reservoir 14, speed of the fan 26, volume of fluid being pumped through the radiator 24 and/or whether one on more of the electronic elements have malfunctioned or are not functioning.

The keyboard or buttons may be utilized for one-touch reporting of information such as a button that provides the internal temperature of the insulated storage chest 12. Alternatively, the keyboard and/or buttons may be used to program the function of the particular elements as desired for the intended use by the user.

In one example, there may be a command that allows the user to obtain the temperature of the interior of the insulated storage chest 12, and if the temperature is low, the user may activate the ice maker 16 to produce more ice based on the amount of water available in the fluid reservoir 14. Correspondingly, the control unit 28 may be programmed by the user to activate the ice maker when the temperature reaches a designated numerical value. Depending on the usage, the ice maker 16 may be able to make ice when the fluid in the water reservoir 14 is sufficiently high to support the production of ice. Alternatively, if the air conditioning unit 18 is being used, the ice maker 16 may make ice less frequently to provide sufficient cooled water for conditioning the air in a desired location. Correspondingly an additional amount of water may be stored in the water reservoir 14 to prevent the reduction in ice production when desired.

In another example, when the air conditioning unit 18 is being used to adjust the temperature of the interior of a tent, there may be a button that the user may use to activate the air-conditioner 18 and control the temperature at which the radiator 24 is cooling the air. Correspondingly, the control unit 28 may be programmed by the user to activate the air conditioning unit 18 when the temperature in the tent reaches a designated numerical value. Depending on the usage, the air conditioner 18 may be able to cool the air in the tent sufficiently when the fluid in the fluid reservoir 14 is sufficiently high and of a particular temperature to support cooling the air. If the temperature drops significant the program may also activate the ice maker 16 to make additional ice to keep the water in the fluid reservoir 14 at a reasonable temperature for cooling the air through the radiator 24.

Other Elements

Other elements may also be included in the device 10 of the present invention including a water cooling means 46 that utilizes energy generated from the energy generating means 32 to power a fluid cooling device for regulating the temperature of the water in the fluid reservoir 14.

The control unit 28 may further comprise one or more outlets 42 for connecting other equipment. These outlets 42 may be similar to outlet plugs in a house, a USB port on a computer or other similar “plug-in” outlets such as those used in countries other than the United States. Other types of equipment might be cell phones for communication, computers, laptops, notepads or other similar devices for collecting information, lights for illumination in the dark, fans, electrical cooking stoves, rechargeable batteries for work tools such as drills, saws and sanders and a variety of other devices requiring energy to operate.

The unique aspect of this device which is not currently available in commercial technologies, is the ability for this device, when used properly, to be self-sustaining for an extended period of time and its ability to re-establish a programmed environmental condition within itself when adversely impacted by, for example, the numerous openings of the lid or a significant increase in the temperature of the fluid in the reservoir when using the air conditioning capability. No other system that provides these elements has this capability.

Presently there is no other device commercially available that can generate ice without being plugged into a generator or power grid. In addition, no portable AC of this nature is capable of cooling for more than 2 hours without depleting all of the ice in the device rendering it ineffective in maintaining a desired temperature and none of these devices are able to power other gear at the same time.

This is the only device that can sustain itself indefinitely without being supported by the power grid or any external device making it capable of cooling for days without depleting the ice which allows for you to continue cooling drinks, food, medicine, etc. while powering lights, laptops, phones, or other devices. All of the currently available commercial devices require an external power source or device to support them in any extended use and none offer the multifunctional capabilities in a self-sustainable device as the present invention.

While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

I claim:

1. A multipurpose ice chest comprising:
an insulated storage chest having sides and a base, wherein said base having a fluid reservoir;
an ice maker affixed within said insulated storage chest, wherein said ice maker having a water uptake system in fluid connection with said fluid reservoir, an ice making chamber for receiving water from said water uptake system, an ice releasing means for dispensing ice from said ice making chamber into said insulated storage chest and an electronic means for controlling said ice maker, wherein said electronic means having a sensor for determining the level of water in said fluid reservoir;
an air conditioning unit, wherein said air conditioning unit having a submersible pump within said fluid reservoir, wherein said submersible pump having an inlet conduit and an outlet conduit, a radiator having and inlet port connected to said inlet conduit and an outlet port connected to said outlet conduit and a fan affixed to said radiator for drawing air through said radiator reducing the temperature of the air being drawn through said radiator;
an electronic control unit in electronic communication with said ice maker and said air conditioning unit for controlling said ice maker and said air conditioning unit; and
a means for generating and storing energy, said energy generating and storage means connected to said electronic control unit.

2. The multipurpose ice chest of claim 1, wherein said energy generating and storage means is a solar panel.

3. The multipurpose ice chest of claim 2, wherein said solar panel further comprises an electrical tether and a structural scaffold for maintaining said solar panel in position.

4. The multipurpose ice chest of claim 3, wherein said structural scaffold for maintaining said solar panel in position is integral to or separable from said insulated storage chest.

5. The multipurpose ice chest of claim 1, wherein said sensor for determining the level of water in said water reservoir is a float.

6. The multipurpose ice chest of claim 1, further comprising a means for cooling the fluid in the fluid reservoir.

7. The multipurpose ice chest of claim 1, further comprising a sensor for determining the temperature of the fluid in the fluid reservoir.

8. The multipurpose ice chest of claim 1, wherein said electronic control unit further comprises one or more outlets for transferring energy to other equipment.
